(19) United States
(12) Patent Application Publication
(10) Pub. No.: US 2005/0017500 A1
(43) Pub. Date: Jan. 27, 2005

(54) OFFICIAL COMMUNITY CALENDAR AND METHOD

(76) Inventor: Richard Brea, Portsmouth, NH (US)

Correspondence Address: DECKER LAW OFFICE, 1 NEW HAMPSHIRE AVE., SUITE 125, PORTSMOUTH, NH, 03801, US

(21) Appl. No.: 10/604,463

(22) Filed: Jul. 23, 2003

(51) Int. Cl. B42D 5/04

(52) U.S. Cl. 283/2

(57) ABSTRACT

A multi-part community calendar having titles of important events in the pages near the front. A user would turn the pages to find the detailed information corresponding to the event titles. Advertising is found on the various pages, and coupons for goods and services relevant to the community would follow. A community calendar page can be provided after the event descriptions, having miscellaneous community information. A business method for producing this calendar includes the steps of receiving and researching community information from the public, preferably by electronic data input. A community administrator also receives advertising and coupons from businesses, and rates charged are related to the total number of households in the community. A calendar for one particular period is published at a time, preferably monthly. The calendar is distributed free of charge to every household in the community.

### BACKGROUND OF INVENTION

a. Field of the Invention

The invention relates to multipart calendars and a business method for using the calendars in the distribution of coupons and advertising relevant to a particular community.

b. Description of the Related Art

The most basic definition of a calendar is an orderly arrangement of the division of time, adapted to the purposes of civil life, as years, months, weeks, and days. Webster's Revised Unabridged Dictionary, 1996. Calendars have been designed and adapted for various specialized purposes. One such calendar is disclosed in U.S. Pat. No. 4,947,564 (the '564 patent), which is not admitted to being prior art by its mention in this background section. The '564 patent describes a multipart calendar for tracking dated information, such as pregnancy, across several months. The calendar of the '564 patent is optimized for tracking a single event or a few events.

Another calendar is disclosed in U.S. Pat. No. 5,135,260 (the '260 patent), which is not admitted to being prior art by its mention in this background section. The '260 patent discloses a yearly calendar with a multi-layer structure, but does not have the ability to record and display events. This calendar is optimizes for its aesthetic qualities.

Yet another calendar is disclosed in U.S. Pat. No. 5,339,546 (the '546 patent), which is not admitted to being prior art by its mention in this background section. The '546 patent discloses a monthly calendar having weeks coded in different colors that correspond to pockets of the same color. Reminders and notes entered on slips of paper are placed in the pockets. With this calendar, it is necessary for the user to find event information and place it in the proper pocket.

None of the calendars available are optimized for presenting community events in a timely manner. Furthermore, there has not existed a business method for timely collecting the information, assembling it in a user-friendly format, and distributing it free of charge to the community. What is needed, therefore, is a community calendar for presenting multiple events in readable format that is updated periodically and distributed free of charge to the community.

### SUMMARY OF INVENTION

An invention that satisfies the need for a community calendar for presenting multiple events in a readable format that is updated periodically and distributed free of charge to the community includes the steps of receiving official, local, and neighboring community event information and paid advertising related to the community; producing a multi-part community calendar with official and local community event information, neighboring community event information, and coupons on different pages; and distributing the calendar free of charge to each household in the community. These and other features, aspects, and advantages of the present invention will become better understood with regard to the following description, claims, and accompanying drawings.

### BRIEF DESCRIPTION OF DRAWINGS

FIG. 1 is a flow chart illustrating one embodiment of the business method of the present invention.

FIG. 2 shows a cover according to the present invention with a means to secure the calendar to a vertical surface.

FIG. 3 shows an example of the local and neighboring community calendars.

FIG. 4 shows an example of local event information pages.

FIG. 5 shows an example of the neighboring community event pages.

FIG. 6 shows an example of a community message board and a coupon page.

### DETAILED DESCRIPTION

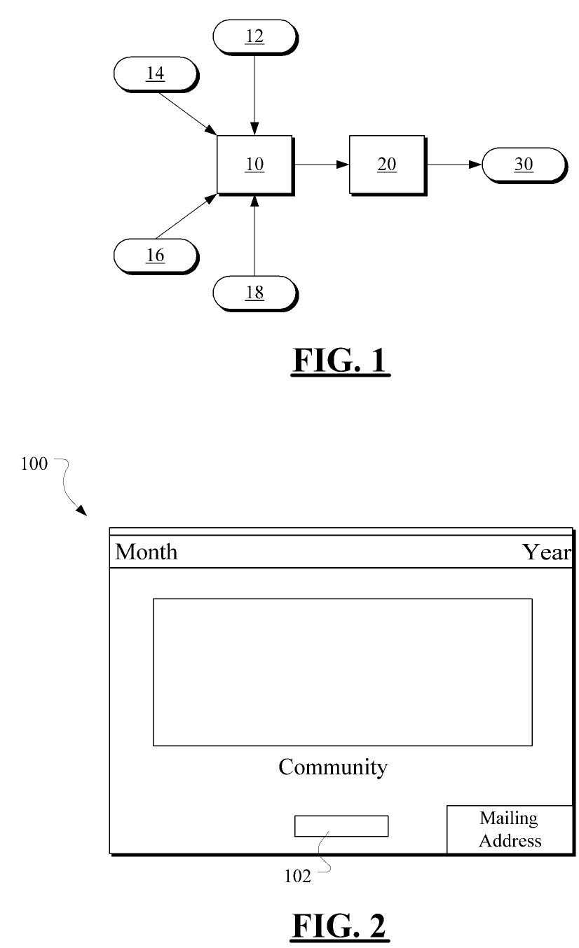

The business method of producing an official community calendar comprises the steps of receiving and researching official, local, and neighboring community event information and paid advertising related to the community; producing a multi-part community calendar with official and local community event information, neighboring community event information, and coupons on different pages; and distributing the calendar free of charge to each household in the community. Turning to FIG. 1, an organization or a person in the role of a community administrator receives or researches 10 information about events related to a community for placement in the calendar. As used herein, it is understood that the term “community administrator” can also include an employee or other agent of the business having duties related to the community. Particularly, the administrator will receive or research official community event information 12 from officials in the community. In this specification, it is understood that the term “community” can mean neighborhood, town, city, county, metropolitan area, or state. However, in the preferred embodiment, the community is a town or city.

The administrator will also receive and research local community event information 14 and neighboring community event information 16. Information received that is not strictly an event may be included in the calendar as community message board items. The administrator will also receive and solicit advertising and coupons 18 from businesses in and around the community.

An important factor to the success of the method is receiving information in a timely manner. Although information can be received by many means, the preferred embodiment uses electronic data entry. Particularly, an Internet Web site may be provided having data input forms corresponding to the calendar format, such as date, time, location, community, and description. In addition to this embodiment, separate e-mail addresses can be provided corresponding to the type of information being offered, such as “events,” “contests,” “advertising,” and the like. Using electronic data entry like this has the benefit of arriving very quickly compared to regular mail, and removes the likelihood of misunderstanding information sent by a telephone call.

The administrator then assembles the information received into a particular format that has been found very desirable by the public. That format is described in detail later in this specification. The administrator then produces 20 a calendar, and then distributes 30 a copy to every household in the community free of charge. The rates charged for advertising are based on the total number of households in the community.

Another feature of the present invention is that no advertising will be accepted that competes with any other advertiser. Because of non-competing advertising, and timeliness of calendar information, this business method is very attractive to advertisers.

FIGS. 2 through 6 show the preferred embodiment of a calendar according to the present invention. FIG. 2 shows the cover page 100, which will be visible when the calendar is placed in the mail. A securing means 102 may be attached near the lower edge to facilitate hanging the calendar on a vertical surface. The securing means 102 is preferably a sticky back hook. The securing means 102 could also comprise a hole through which a hook could be placed, or a magnet.

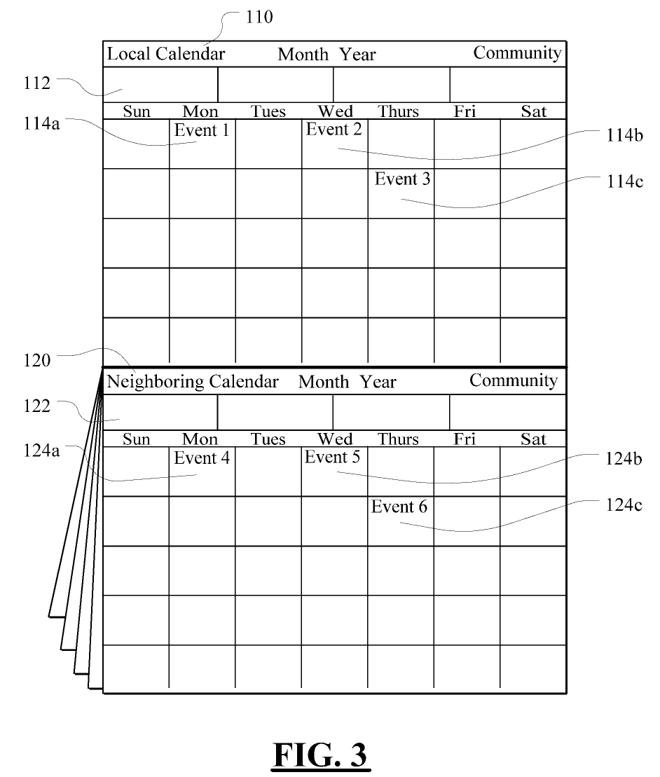

FIG. 3 shows the first top page of an unfolded calendar. The top page is the Local Calendar 110. The name of the community and the date will appear on this page, as well as the familiar table of dates and days of the week making up a calendar. Although the preferred embodiment is a monthly calendar, published one month at a time, the calendar can also cover other periods of time. Event titles 114a, 114b, 114c are arranged on their appropriate dates on the calendar.

The first bottom page of the unfolded calendar is the Neighboring Calendar 120. It is at the bottom because it is of secondary importance to the Local Calendar 110, but still very relevant to the public. Like the Local Calendar 110, the Neighboring Calendar 120 has the name of the community and date, as well as another table of dates and days. Event titles 124a, 124b, 124c for events in neighboring communities are arranged on their appropriate dates. Advertising 112 would appear on the Local Calendar page 110. Coupons and/or reminders 122 would appear on the Neighboring Calendar 120.

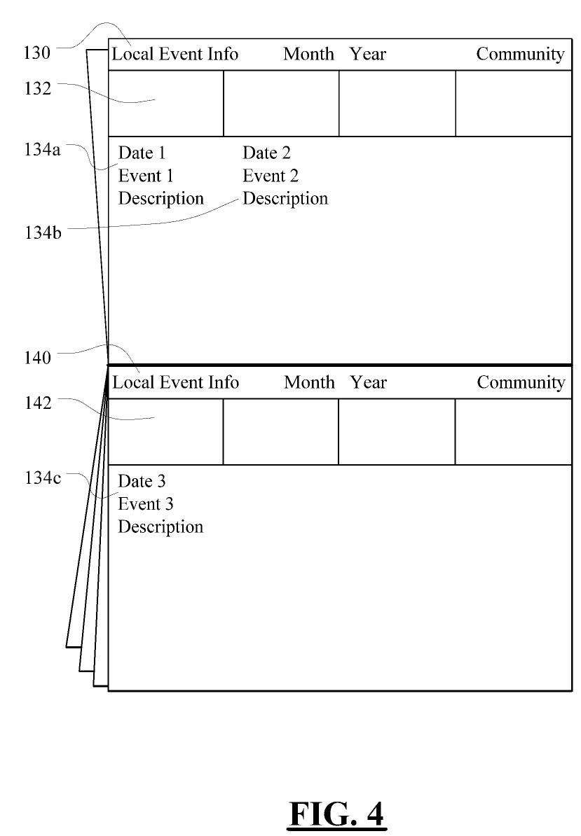

FIG. 4 shows the next pages of the multi-part calendar. Both the top and bottom pages are detailed Local Event Information pages 130, 140. These pages do not have a calendar table. Instead detailed descriptions 134a, 134b, 134c are presented under the event titles corresponding to those on the Local Calendar, and are listed in date order. Although two Local Event Information pages are shown in FIG. 4, more or fewer can be provided. Advertising spaces 132, 142 are provided on these pages. The advertising spaces are shown in a particular location in FIG. 4, but they may appear anywhere on the page. In the preferred embodiment, two Local Event Information pages are provided.

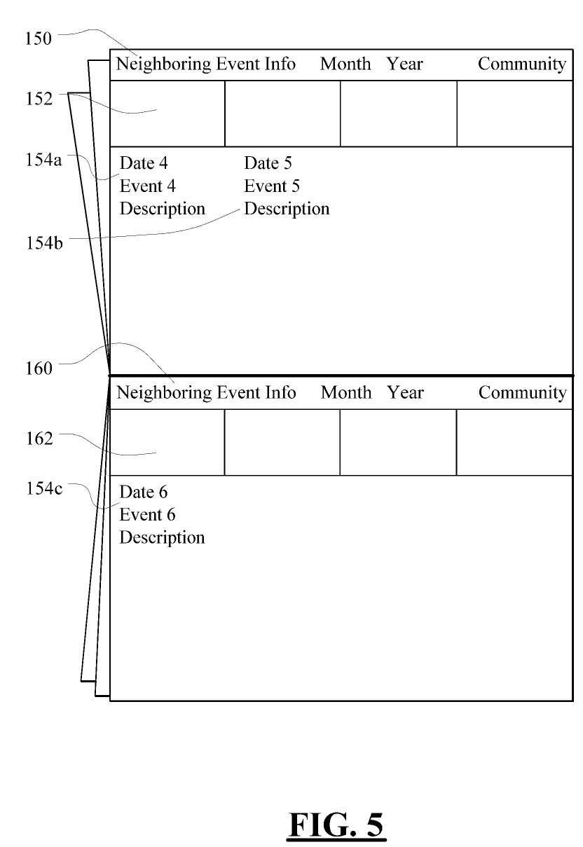

FIG. 5 shows the next pages of the multi-part community calendar. Both the top and bottom pages are detailed Neighboring Event Information pages 150, 160. Like the previous pages, they do not have a calendar table. Instead, detailed descriptions 154a, 154b, 154c are presented under the event titles corresponding to those on the Neighboring Calendar 120, and are listed in date order. More or fewer than two pages can be provided. Advertising spaces 152, 162 are provided on these pages. Like with the Local Event Information pages 150, 160, advertising can appear anywhere on the pages.

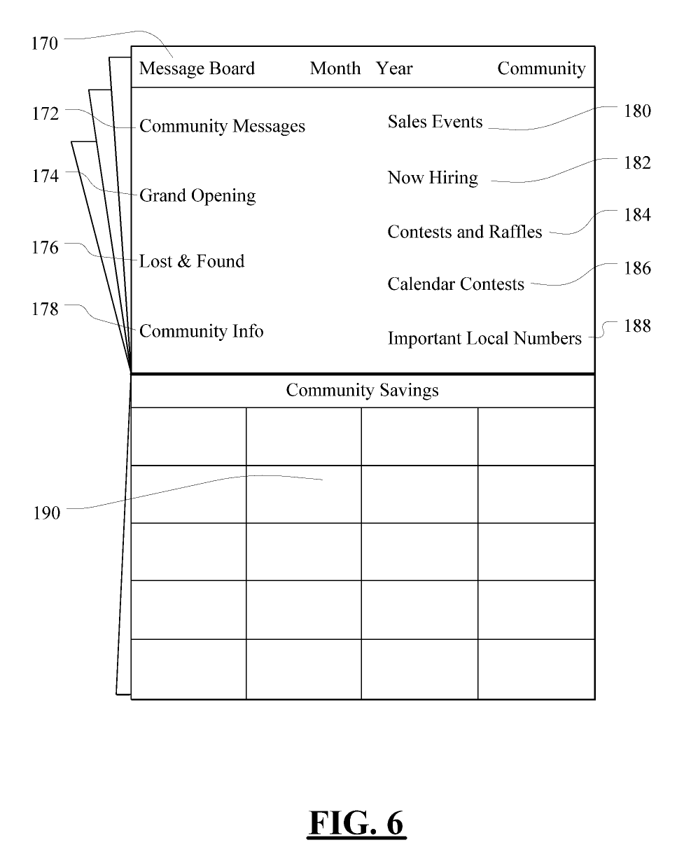

FIG. 6 shows the next pages of the multi-part community calendar. The top page is the Community Message Board 170, and displays information that did not make the events pages, or is not pertinent to a particular date. Examples of the categories of information on the Community Message Board 170 may include, but are not limited to, Community Messages 172, Grand Openings 174, Lost and Found 176, Community Information 178, Sales Events 180, Now Hiring 182, Contests and Raffles 184, Calendar Contests 186, and Important Local Phone Numbers 188.

The bottom page is a Community Savings coupon page 190. Additional coupon pages, if desired, follow this page.

In summary, the multi-part calendar has titles of important event in the pages near the front. A user would turn the pages to find the detailed information corresponding to the event titles. Advertising is found on the Calendar and Event pages, and coupons for goods and services relevant to the community would appear on the Community Savings pages. A Community Message Board page can be provided after the event descriptions, having miscellaneous community information. A business method for producing this calendar includes the steps of receiving and researching community information from the public, preferably by electronic data input and by contacting event organizers. A community administrator also receives and solicits advertising and coupons from businesses, and rates charged are related to the total number of households in the community. A calendar for one particular period is published at a time, preferably monthly. The calendar is distributed free of charge to every household in the community by mail.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

1. A method for operating a community calendar business comprising the steps of
obtaining local community event information related to the community, and
receiving paid advertising related to the community, followed by
producing a multi-part community calendar containing the official community event information, local community event information, and advertising, and followed by distributing the community calendar to substantially all of the households in the community.

2. The method of claim 1 further comprising obtaining receiving neighboring community event information.

3. The method of claim 2, the obtaining step comprising at least one of receiving community event information from an official in the community, receiving community event information from members of the public, and researching community event information.

4. The method of claim 1, wherein none of the advertising distributed in the calendar is competitive with other advertising in the same calendar.

5. The method of claim 1, wherein a price for the paid advertising is calculated based on a total number of households in the community.

6. The method of claim 3, wherein the official community event information, local community event information, and neighboring community event information is obtained and distributed free of charge.

7. The method of claim 1, wherein the community is one taken from the group consisting of a town, city, county, and state.

8. The method of claim 1, wherein the method is managed by a community administrator.

9. The method of claim 1, the multi-part community calendar comprising
a combined official and local community calendar page having event titles,
a neighboring community calendar page having event titles,
at least one event information page having more detailed event information corresponding to the event titles, and a community messages page.

10. The method of claim 9 further comprising at least one coupon page.

11. The method of claim 9, the community message board page comprising at least one of a community messages section, grand opening section, lost and found section, community information section, sales events section, now hiring section, contests and raffles section, calendar contests section, and important local phone numbers section.

12. The method of claim 9, the multi-part community calendar further comprising a securing means affixed to the calendar suitable for removably securing the calendar to a metal surface.

13. The method of claim 12, wherein the securing means is at least one of a sticky back hook and a hole for receiving a hook.

14. A multi-part community calendar comprising a combined official and local community calendar page having event titles,
a neighboring community calendar page having event titles,
at least one event information page having more detailed event information corresponding to the event titles, and a community messages page.

15. The calendar of claim 14 further comprising at least one coupon page.

16. The calendar of claim 14, wherein the local community calendar page and neighboring calendar pages are arranged one over the other when the calendar is displayed.

17. The calendar of claim 14 further comprising a community message board page having at least one of a community messages section, grand opening section, lost and found section, community information section, sales events section, now hiring section, contests and raffles section, calendar contests section, and important local phone numbers section.

18. The calendar of claim 14 further comprising a securing means affixed to the calendar suitable for removably securing the calendar to a surface.

19. The calendar of claim 18, wherein the securing means is at least one of a sticky back hook and a hole adapted to receive a hook.

20. The calendar of claim 14 further comprising advertising on at least one of the pages.

21. The calendar of claim 14, wherein the calendar is a monthly calendar and is made of between 11 inch×17 inch, and 12 inch by 18 inch, nominal size paper.

22. The calendar of claim 14 further comprising a cover identifying the month, year, and community.
